(19) United States
(12) Patent Application Publication
(10) Pub. No.: US 2011/0111804 A9
(43) Pub. Date: May 12, 2011

(54) Tower top amplifier directly and detachably attached to antenna

(75) Inventors: Duk-Yong Kim, Yongin-si (KR); Byung-Chul Kim, Osan-si (KR); Won-Kil Park, Suwon-si (KR)

(73) Assignee: KMW, Inc.

(21) Appl. No.: 11/517,896

(22) Filed: Sep. 8, 2006

Related U.S. Application Data
(63) Continuation of application No. PCT/KR04/01230, filed on May 24, 2004.

(30) Foreign Application Priority Data
Mar. 10, 2004 (KR) 16163/2004

(51) Int. Cl. H04M 1/03

(52) U.S. Cl. 455/562.1

(57) ABSTRACT

Disclosed is a tower top amplifier directly and detachably attached and electrically connected to an antenna of a base station for mobile communication. The tower top amplifier includes a tower top amplifying unit (20) connected to an antenna unit (10), and a connecting unit (30) provided on one surface of the antenna unit (10) for connecting the tower top amplifying unit (20) and the antenna unit (10). The tower top amplifying unit (20) is directly attached and electrically connected to the antenna unit (10) without any cable, thereby causing the tower top amplifier to be simply assembled and disassembled. The tower top amplifier does not require the cable exposed to the outside, thus having an aesthetic appearance. The tower top amplifying unit (20) having the same shape as that of the antenna unit (10) is detachably attached to the antenna unit (10), thereby being formed integrally with the antenna unit(10).

### TECHNICAL FIELD

The present invention relates to an antenna of a base station for mobile communication, and more particularly to a tower top amplifier directly and detachably attached to an antenna without using a separate cable.

### BACKGROUND ART

Now, general transmitting and receiving operation of a base station system for mobile communication will be described. A signal to be transmitted is amplified by a high power amplifier disposed in a base station, and is transmitted to an antenna installed on a tower through a feeder cable. Then, a transmitting antenna duplicates the signal into a space. On the other hand, a signal duplicated by a subscriber's antenna and received by a receiving antenna is transmitted to a low noise receiving amplifier disposed in the base station through the feeder cable. Then, the low noise amplifier amplifies the received signal from a low intensity to a high intensity required by the base station.

Generally, the base station system for mobile communication is installed on the top of a downtown building. Here, an antenna is installed on an antenna supporter or a tower top so that the antenna is located above the base station system. Accordingly, the base station system and the antenna, which are installed outdoors, are spaced from each other by a comparatively long distance. In order to prevent the signal attenuation, an expensive low-loss and high-power cable is used as the feeder cable.

The length of wiring between the base station system and the antenna is several tens of meters, thereby generating power consumption corresponding to ½ (3 dB) of an input signal when the signal is received by the antenna. That is, when the signal is received by the antenna, noise is increased and receiving sensitivity is reduced. In order to transmit a signal, a high power amplifier, which is expensive and has a large size and low efficiency, is required. As described above, in case that the antenna is distant from the base station system, power loss caused due to the length of a transmission line for connecting the antenna and the base station system deteriorates the performance of the system. In order to compensate for the deterioration of the performance of the system, a tower top amplifying apparatus having improved transmission and reception performance, in which transmitting and receiving filters and an amplifier are close to the antenna, is used.

However, since the tower top amplifying apparatus may be used or may not be used according to circumstances of the base station, the antenna of the base station and the tower top amplifying apparatus are separately manufactured and are then connected to each other. Generally, the tower top amplifying apparatus is installed at a lower end of the antenna so that the tower top amplifying apparatus is connected to the antenna by a cable. As described above, the conventional tower top amplifying apparatus is connected to the antenna by the cable, thus causing inconvenience to workers, having a messy appearance, and increasing the probability of water leakage and installation costs.

### DISCLOSURE OF THE INVENTION

Therefore, the present invention has been made in view of the above problems, and it is an object of the present invention to provide a tower top amplifier directly and detachably attached to an antenna of a base station without using a cable, thereby being easily installed on and separated from the base station.

It is another object of the present invention to provide a tower top amplifier directly and detachably attached and electrically connected to an antenna of a base station without using a cable, thereby causing communication equipment to have an aesthetic appearance.

It is yet another object of the present invention to provide a tower top amplifier, having the same shape of an antenna of a base station, directly and detachably attached and electrically connected to the antenna without using a cable, thereby being formed integrally with the antenna.

In accordance with the present invention, the above and other objects can be accomplished by the provision of a tower top amplifier directly and detachably connected to an antenna unit of an antenna system in a base station for mobile communication, comprising: a tower top amplifying unit connected to the antenna unit for amplifying transmitted and received signals; and a connecting unit provided on one surface of the antenna unit for directly connecting the tower top amplifying unit and the antenna unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of a tower top amplifier directly and detachably attached to an antenna in accordance with an embodiment of the present invention;

FIG. 2 is a perspective view of one surface of a connecting unit of the tower top amplifier directly and detachably attached to the antenna in accordance with the embodiment of the present invention;

FIG. 3 is a perspective view of the other surface of the connecting unit of the tower top amplifier directly and detachably attached to the antenna in accordance with the embodiment of the present invention;

FIG. 4 is a longitudinal-sectional view, taken along the line A-A′ of FIG. 3, illustrating the connecting unit of the tower top amplifier directly and detachably attached to the antenna in accordance with the embodiment of the present invention; and

FIG. 5 is a longitudinal-sectional view of the tower top amplifier, in a used state, directly and detachably attached to the antenna in accordance with the embodiment of the present invention.

### BEST MODE FOR CARRYING OUT THE INVENTION

Now, the most preferred embodiment of the present invention will be described in detail with reference to the annexed drawings.

Generally, an antenna unit of a base station for mobile communication has the structure of a laser dome having a circular or hemispherical pillar shape. In the present invention, an antenna including the structure of the laser dome having a circular pillar shape will be exemplarily descried.

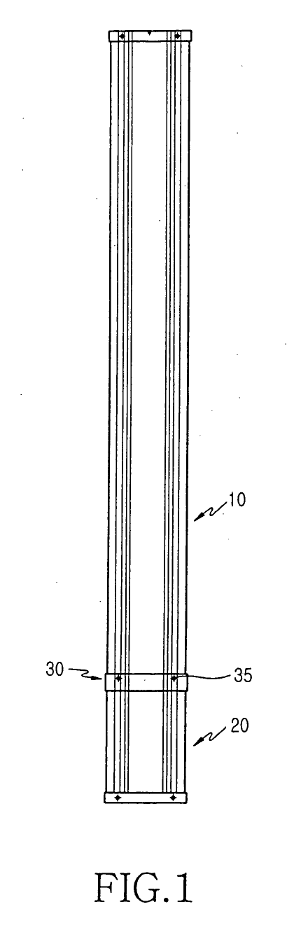

FIG. 1 is a front view of a tower top amplifier directly and detachably attached to an antenna in accordance with an embodiment of the present invention. As shown in FIG. 1, the tower top amplifier comprises an antenna unit 10, a tower top amplifying unit 20, and a connecting unit 30 disposed on a lower surface of the antenna unit 10 for directly connecting the antenna 10 and the tower top amplifying unit 20 without using a cable.

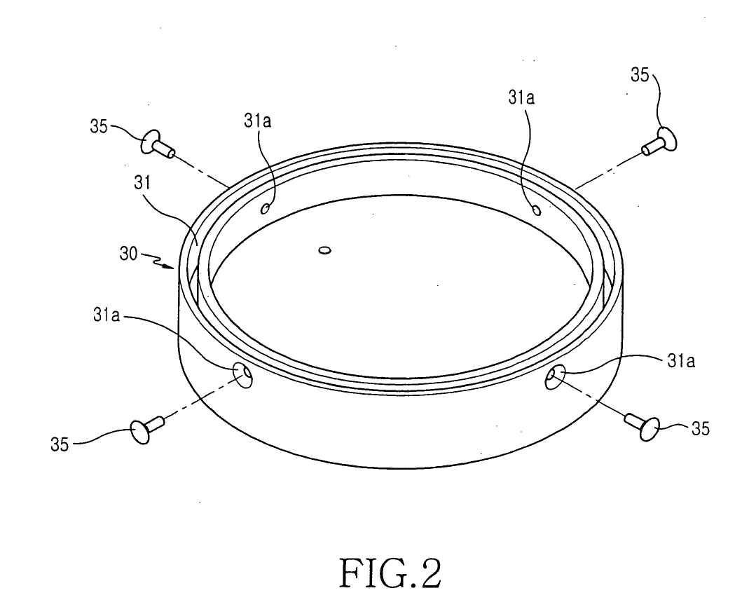

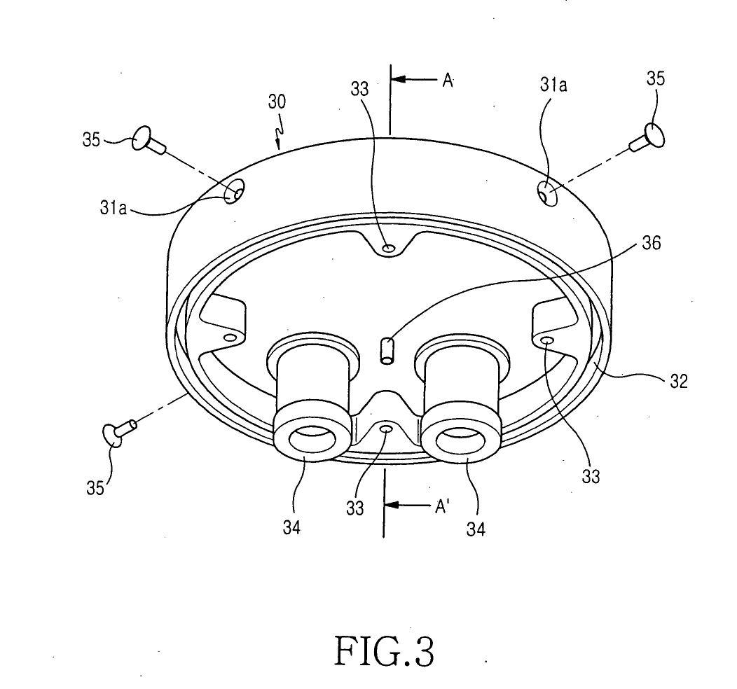

As shown in FIGS. 2 and 3, a first connection groove 31 is formed in the edge of an upper surface of the connecting unit 30 so that an end of an external case of the antenna unit 10 is connected to the upper surface of the connecting unit 30 by the first connection groove 31, and a second connection groove 32 is formed in the edge of a lower surface of the connecting unit 30 so that an end of an external case of the tower top amplifying unit 20 is connected to the lower surface of the connecting unit 30 by the second connection groove 32.

Four second screw holes 31a are formed through the circumference of the upper portion of the connecting unit 30 provided with the first connection groove 31 in a perpendicular direction of the first connection groove 31 so that the four second screw holes 31a coincide with four first screw holes formed through the circumference of the lower end of the external case of the antenna unit 10.

Further, four third screw holes 33 are formed at designated positions of the lower surface of the connecting unit 30.

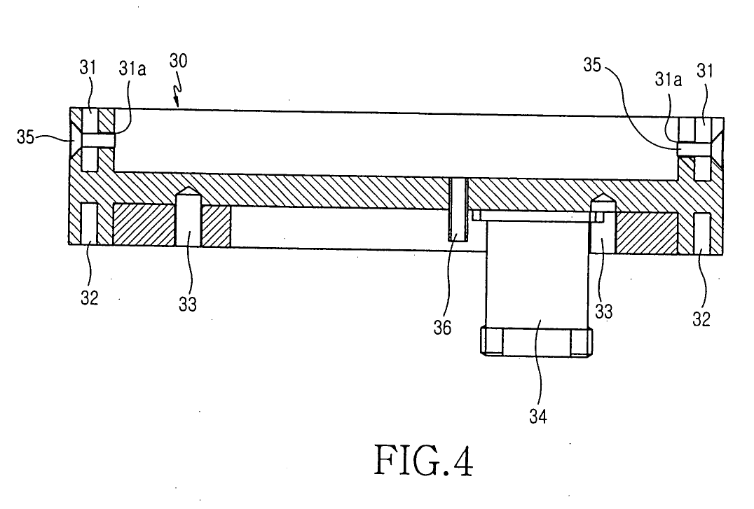

As shown in FIG. 4, a feeding port 34 of the antenna unit 10 is disposed at a designated position of the lower surface of the connecting unit 30. Here, a snap-on-type connector is used as the feeding port 34.

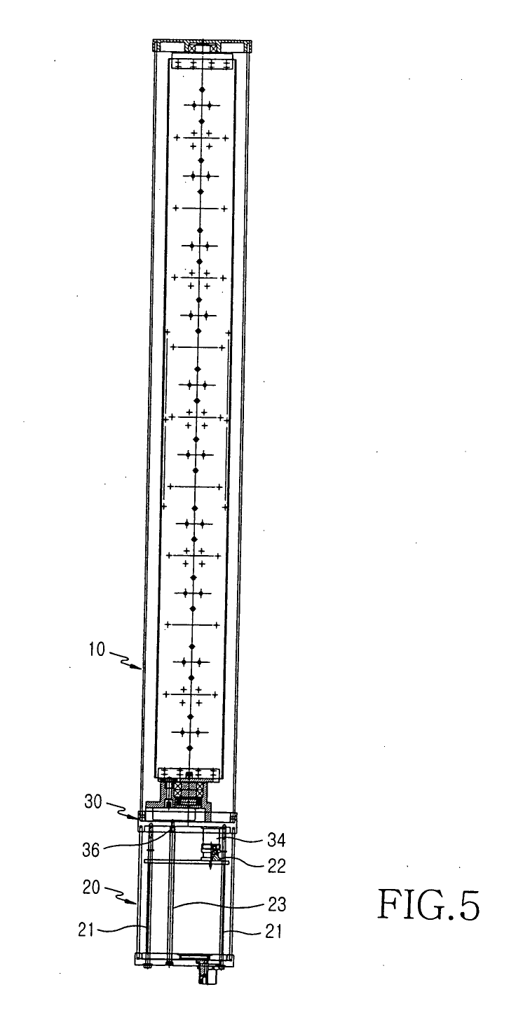

As shown in FIG. 5, the external case of the tower top amplifying unit 20 has the same diameter as that of the external case of the antenna unit 10, and is configured such that the external case of the tower top amplifying unit 20 can be inserted into the second connection groove 32 of the connecting unit 30.

Four second screws 21 are inserted into designated positions of the lower surface of the tower top amplifying unit 20 so that the second screws 21 pass through the tower top amplifying unit 20 in a longitudinal direction, and are then connected to the third screw holes 33 formed in the lower surface of the connecting unit 30.

A feeding port 22 is disposed at a designated position of the upper surface of the tower top amplifying unit 20, and a snap-on-type connector is used as the feeding port 22.

A drain port 23 for discharging moisture to the outside therethrough is disposed between the lower end of the antenna unit 10 and the upper end of the tower top amplifying unit 20, and a snap-on-type connector is also used as the drain port 23.

Hereinafter, operation of the tower top amplifier in accordance with the preferred embodiment of the present invention will be described in detail with reference to the annexed drawings.

First, the lower end of the external case of the antenna unit 10 is inserted into the first connection groove 31 of the connecting unit 30, thereby allowing the connecting unit 30 to serve as a lower cap of the antenna unit 10.

Here, the four first screw holes formed through the circumference of the lower end of the external case of the antenna unit 10 coincide with the four second screw holes 31 a formed through the circumference of the upper portion of the connecting unit 30 in the longitudinal direction of the first connection groove 31, and then the four first screw holes are fixed to the four second screw holes 31a by first screws 35.

In case that only an antenna is required, the antenna unit 10 attached to the connecting unit 30 is installed directly on a tower top, etc.

Thereafter, in case that a tower top amplifier is additionally required, the upper end of the external case of the tower top amplifying unit 20 provided with the transmitting and receiving filters and amplifiers is inserted into the second connection groove 32 formed in the lower surface of the connecting unit 30.

Here, as shown in FIG. 5, the feeding port 34 and the drain port 36 disposed on the lower end of the connecting unit 30 and the feeding port 22 and the drain port 23 disposed on the upper end of the tower top amplifying unit 20 are snap-on-type connectors, thus being easily connected to each other simply by pushing the tower top amplifying unit 20 into the second connection groove 32.

Thereafter, the second screws 21 having passed through the tower top amplifying unit 20 in the longitudinal direction coincide with the third screw holes 33 formed at the designated positions of the lower surface of the connecting unit 30, and are then fixedly inserted into the third screw holes 33.

The tower top amplifying unit 20 of the tower top amplifier of the present invention is connected to the antenna unit 10 without using any additional cable.

Further, the tower top amplifying unit 20 is directly connected to the antenna unit 10 in a single external case, thereby constituting an integral base station antenna system.

On the other hand, in order to separate the tower top amplifying unit 20 from the antenna unit 10, the second screws 21 are eliminated from the third screw holes 33, and the tower top amplifying unit 20 is detached from the second connection groove 32 of the connecting unit 30, thereby allowing the tower top amplifying unit to be simply separated from the second connection groove 32.

Since the feeding port 34 and the drain port 36 of the connecting unit 30 and the feeding port 22 and the drain port 23 of the tower top amplifying unit 20 are snap-on-type connectors, the feeding port 34 and the drain port 36 of the connecting unit 30 are separated from the feeding port 22 and the drain port 23 of the tower top amplifying unit 20 simply by pushing the feeding port 34 and the drain port 36 out of the feeding port 22 and the drain port 23.

### INDUSTRIAL APPLICABILITY

As apparent from the above description, the present invention provides a tower top amplifier directly and detachably connected to an antenna.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A tower top amplifier directly and detachably connected to an antenna unit of an antenna system in a base station for mobile communication, comprising:
a tower top amplifying unit connected to the antenna unit for amplifying transmitted and received signals; and
a connecting unit provided on one surface of the antenna unit for directly connecting the tower top amplifying unit and the antenna unit.

2. The tower top amplifier as set forth in claim 1, wherein the connecting unit has a ring or hemispherical shape, and a connection groove is formed in one surface of the connecting unit and connected to the end of an external case of the tower top amplifying unit.

3. The tower top amplifier as set forth in claim 1, wherein:
a plurality of screw holes are formed at designated positions of one surface of the connecting unit in a longitudinal direction of the tower top amplifying unit; and
a plurality of screws pass through the tower top amplifying unit in the longitudinal direction and are inserted into the screw holes.

4. The tower top amplifier as set forth in claim 1, wherein a feeding port formed at a designated position of one surface of the connecting unit and a feeding port formed on the upper portion of the tower top amplifying unit are snap-on-type connectors so that the feeding ports are connected to each other without using a cable.

5. The tower top amplifier as set forth in claim 1, wherein a drain port formed at a designated position of one surface of the connecting unit and a drain port formed on the upper portion of the tower top amplifying unit are snap-on-type connectors so that the drain ports are connected to each other without using a cable.
